(19) United States
(12) Patent Application Publication
(10) Pub. No.: US 2019/0262990 A1
(43) Pub. Date: Aug. 29, 2019

(54) ROBOT SKILL MANAGEMENT

(71) Applicant: MISTY ROBOTICS, INC., Boulder, CO (US)

(72) Inventors: Daniel H. Grollman, Boulder, CO (US); Ian Bernstein, Boulder, CO (US)

(73) Assignee: MISTY ROBOTICS, INC., Boulder, CO (US)

(21) Appl. No.: 15/907,561

(22) Filed: Feb. 28, 2018

(51) Int. Cl. B25J 9/16; G05B 19/042

(52) U.S. Cl. CPC B25J 9/163; G05B 19/042; Y10S 901/02; G05B 2219/40302; B25J 9/1661

(57) ABSTRACT

Aspects of the present disclosure generally relate to robot skill management. In certain aspects, a robot may be capable of performing a set of skills. Accordingly, the robot may implement aspects of robot skill management to determine a skill to execute without requiring user input prior to executing the skill. In an example, a skill relevancy metric may be determined for a skill, which may be determined based on context information for the robot. Further, the robot may maintain metadata for the skill relating to previous instances in which the skill was executed. As a result, the robot may generate a skill importance metric based at least in part on the skill relevancy metric and/or the skill metadata. Skill importance metrics for the set of skills may then be used to determine a skill from the set. The determined skill may then be executed by the robot.

### BACKGROUND

Traditionally, a robot may execute one or more skills in response to activation by a user. Prior to receiving an activation, the robot may exhibit one or more idle behaviors, which may indicate that no skills are presently being executed and/or that the robot is ready to receive user input. However, such behavior may yield a robot that only executes skills at the specific direction of the user, which may burden the user with micro-managing the behavior of the robot, limit the ability of the robot to express its personality, or cause the robot to be underutilized.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Aspects of the present disclosure generally relate to robot skill management. In certain aspects, a robot may be capable of performing one or more skills. Accordingly, the robot may implement aspects of robot skill management as disclosed herein in order to execute a skill without requiring user input. In an example, a skill relevancy metric may be determined for a skill based on context information for the robot. Further, the robot may maintain metadata for the skill relating to previous instances in which the robot has executed the skill. As a result, the robot may be able to generate a skill importance metric based at least in part on the skill relevancy metric and/or the skill metadata. The skill importance metric may then be used to evaluate the skill in relation to skill importance metrics for other skills, such that the robot may determine a skill from the set of skills. The determined skill may then be executed by the robot.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1A depicts an example of a robotic device.

FIG. 1B depicts a more detailed depiction of an example of the control system in the robot.

FIG. 2 depicts an example of a method for robot skill management.

FIG. 3 depicts an example of a method for determining a skill relevancy metric for a skill.

FIG. 4 depicts an example of a method for determining a skill importance metric for a skill.

FIG. 5 depicts an example of a method for executing a skill by a robot.

FIG. 6 illustrates one example of a suitable operating environment in which one or more of the present embodiments may be implemented.

### DETAILED DESCRIPTION

Various aspects of the disclosure are described more fully below with reference to the accompanying drawings, which form a part hereof, and which show specific example aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

In an example, a robot may be able to execute a skill in order to perform a task. Traditionally, a user may provide an instruction to the robot regarding the task, thereby causing the robot to execute a skill associated with performing the task. However, traditionally, the robot may not automatically begin skill execution, and may instead engage in one or more idle behaviors prior to receiving input from the user. In some examples, an idle behavior may indicate that the robot is not executing a skill and/or is available to receive user input. As a result of engaging in such idle behaviors rather than executing a skill, the user may feel overly responsible for controlling the behavior of the robot. Further, it may be difficult for the robot to express its personality, if the only avenue for doing so is while executing skills at the direction of the user. Additionally, in such scenarios, the robot may be underutilized or may not perform tasks when it otherwise may be able to do so.

Accordingly, the present disclosure provides systems and methods for robot skill management. In an example, a robot may evaluate a set of skills in order to determine which skill should be executed by the robot. As a result, the robot may initiate skill execution without requiring user input, such that the robot may perform a task without the user requesting the robot to perform the task, which may thereby enable the robot to express aspects of its personality without first receiving user input, and may also provide additional utility to the user.

As used herein, a task may be any of a wide variety of tasks, including, but not limited to, tasks that involve physical movements (e.g., opening a door, cleaning up a room, etc.), computer operations (e.g., querying a search engine, retrieving weather data, etc.), or any combination thereof. A skill may comprise a set of operations useable by a robot to perform a task. For example, if a task comprises determining the weather, a skill useable to perform the task may comprise instructions for querying a weather service for weather data. In another example, the skill may comprise instructions to move the robot outside or to a window to visually determine the current weather. In some examples, a skill may comprise multiple sets of instructions for performing a task, such that the robot may perform the task using any of the different sets of instructions. While example skills are discussed herein, it will be appreciated that a skill may comprise any of a variety of instructions.

A robot may have a set of one or more skills useable to complete a variety of tasks. In some examples, a skill may be pre-programmed and provided with the robot (e.g., by a manufacturer of the robot), developed by a third-party and installed on the robot, or dynamically generated, among other examples. According to aspects disclosed herein, the robot may manage the set of skills in order to select and execute a skill without requiring user input. As an example, the robot may evaluate context information (e.g., as may be generated based on sensor information, user input, stored or historical information, information from external sources, environmental factors, etc.), metadata associated with previous executions of the skill, and/or factors associated with other skills in the set, among other factors, to select the skill. In some examples, the evaluation may occur periodically and/or in response to the occurrence of an event. In other examples, the evaluation may occur while the robot is executing a skill, such that the robot may halt or pause execution of one skill in order to begin or resume execution of another skill.

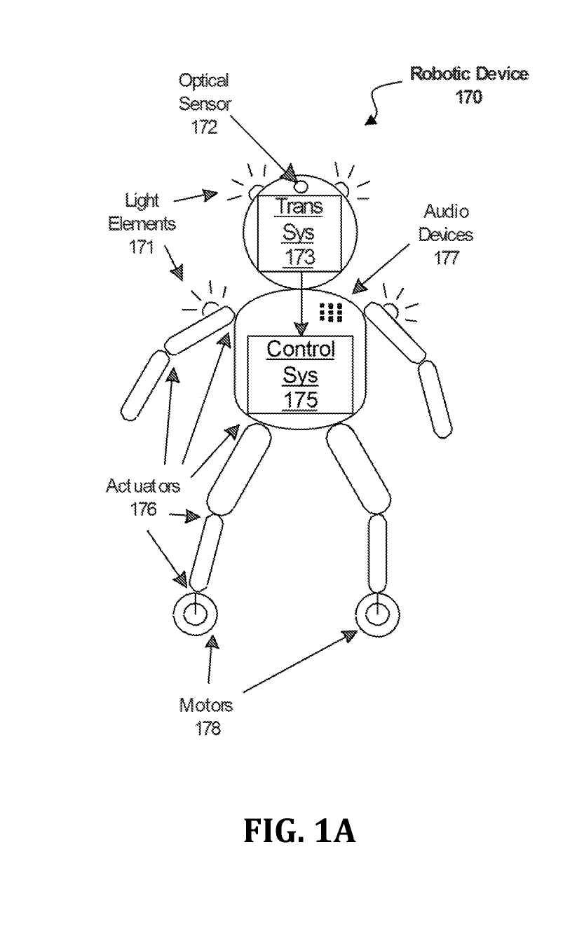

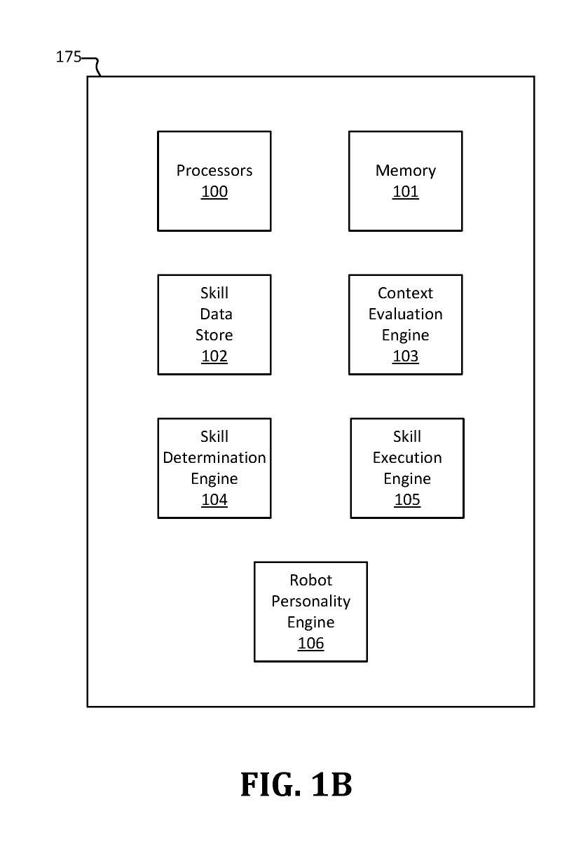

FIG. 1A depicts an example of a robotic device 170. The terms “robotic device” and “robot” are used interchangeably herein. Further, it will be appreciated that while examples herein are described with respect to a robot, similar techniques may be utilized by any of a wide array of other computing devices, including, but not limited to, personal computing devices, desktop computing devices, mobile computing devices, and distributed computing devices.

The robotic device 170 can move in a plurality of manners and can provide feedback through a variety of output mechanisms, so as to convey expressions. For example, the robotic device 170 may include light elements 171 and audio devices 177. The light elements 171 may include LEDs or other lights, as well as displays for displaying videos or other graphical items. The audio devices 177 may include speakers to provide audio output from the robot 170. A plurality of actuators 176 and motors 178 may also be included in the robot 170 to allow the robot to move as a form of communication or in response to user input. In addition, a plurality of input devices may also be included in the robot 170. For example, the audio devices 177 may also include a microphone to receive sound inputs. An optical sensor 172, such as a camera, may also be incorporated into the robot 170 to receive images or other optical signals as inputs. Other sensors, such as accelerometers, GPS units, thermometers, timers, altimeters, or any other sensor, may also be incorporated in the robot 170 to allow for any additional inputs that may be desired.

The robot 170 may also include a transmission system 173 and a control system 175. The transmission system 173 includes components and circuitry for transmitting data to the robot from an external device and transmitting data from the robot to an external device. Such data transmission allows for programming of the robot 170 and for controlling the robot 170 through a remote control or app on a smartphone, tablet, or other external device. In some examples, inputs may be received through the external device and transmitted to the robot 170. In other examples, the robot 170 may use the transmission system 173 to communicate with an external device over a network (e.g., a local area network, a wide area network, the Internet, etc.). As an example, the robot 170 may communicate with an external device that is part of a cloud computing platform. The control system 175 includes components for controlling the actions of the robot 170. In some examples, the control system 175 comprises components for providing a robot personality, according to aspects disclosed herein.

FIG. 1B depicts a more detailed depiction of an example of the control system 175 in the robot 170. The control system 175 includes one or more processors 100 and a memory 101 operatively or communicatively coupled to the one or more processors 100. The one or more processors 100 are configured to execute operations, programs, or computer executable instructions stored in the memory 101. The one or more processors 100 may be operable to execute instructions in accordance with the robot skill management technology described herein. Memory 101 may be volatile memory (such as RAM), non-volatile memory (such as ROM, flash memory, etc.), or some combination of the two. Memory 101 may comprise computer storage media. Computer storage media includes volatile and nonvolatile, removable and non-removable, non-transitory media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. In one example, memory 101 is operable to store instructions for executing methods or operations in accordance with aspects described herein. The instructions may be stored as software or firmware in the control system 175.

The control system 175 also includes a skill data store 102, a context evaluation engine 103, a skill determination engine 104, a skill execution engine 105, and a robot personality engine 106. It will be appreciated that the functionality described herein with respect to the control system 175 and other aspects of the robot 170 may be provided at least in part by an external device, in some examples.

In an example, a personality for the robot 170 may be defined by robot personality engine 106 as a personality location within a unidimensional or multidimensional personality space, which may be associated with one or more factors (e.g., dimensions). As an example, dimensions of a personality space may comprise factors relating to openness, conscientiousness, agreeableness, extrovertedness, and neuroticism. Accordingly, a personality location within the personality space may be associated with different values and/or weightings for each of the factors. While example factors are discussed herein, it will be appreciated that any of a wide variety of factors may be used as dimensions for a personality space.

The personality defined by the robot personality engine 106 may be preprogrammed or randomly selected when the robot 170 is first powered on. In some examples, certain regions of the personality space may be disabled or otherwise avoided, such that a robot may not have a personality represented by personality locations within such regions. In other examples, a user interface may be provided to a user for evaluating a set of potential personalities or personality types, such that the user may identify a personality and/or personality type preferred by the user. In some examples, the user interface may be part of a website or a mobile application. In such an example, the user may make a selection, provide answers to a questionnaire, or provide other input, which may be used to determine the personality of the robot 170.

In some instances, the personality of the robot 170 may be adjusted. As an example, a user may be able to modify the personality, or may be able to request the personality of the robot 170 be modified. In another example, the robot personality engine 106 may adjust the personality of a robot based upon input received over time. For example, the personality location of the robot 170 may be adjusted in a personality space based upon input received by the robot. Example input may be related to interactions with a user, environmental conditions, and actions performed by the robot, among other input. As an example, a user may provide positive reinforcement to a robot in order to encourage perceived good behavior and/or negative reinforcement to discourage perceived bad behavior, which may eventually cause the personality location of the robot to shift within the personality space, thereby adjusting the personality of the robot.

In an example, the robot personality engine 106 may also define an affective state for the robot 170. The affective state of the robot 170 may be represented as an affect location within an affect space. In some example, the affect space may be unidimensional or multidimensional, such that the affective state of the robot may be based on one or more factors, as may be described by the affect location in the affect space. In other examples, the affect space may be continuous or may be comprised of a set of discrete locations. In another examples, the affect space may be bounded and/or infinite. The affect location in the affect space may change, thereby representing a change in the affective state of the robot. In another example, dimensions of the affect space may comprise factors relating to a psychological model, such as the pleasure, arousal, and dominance model. While example factors are described herein, it will be appreciated that any of a variety of factors may be used to define an affective state. In some examples, the personality of the robot 170 may be used by the robot personality engine 106 when determining the affective state of the robot 170.

In an example, the affective state defined by the robot personality engine 106 may be determined based on input received by the robot 170 (e.g., interactions with a user, environmental conditions, actions performed by the robot, etc.). The input may be processed by the robot personality engine 106 according to the personality of the robot 170, such that different robots with different personalities may respond to the same input differently.

As an example, at least a subset of inputs received by the robot may be assigned anchor locations within the affect space based on the personality of the robot 170. In some examples, an anchor point for an input may be determined based on the personality of a robot. The robot personality engine 106 may use the anchor locations to determine an affective state for the robot 170. For example, the robot personality engine 106 may generate an average location within the affect space based on the anchor points, may determine the affect location based on a selection of one or more anchor points, or may use any of a variety of models. In other examples, additional anchor locations may be generated within the affect space, such as an anchor location representing a mood for the robot (e.g., an average affective state for the robot over a given time period, a lingering sentiment resulting from an input that is no longer present, etc.). In another example, the determination may comprise evaluating the previous affective state for the robot, such that the determined affective state may shift in a continuous manner.

In other examples, inputs may be used by the robot personality engine 106 to directly modify the affective state of the robot 170, such that an input may be used to determine a change that should be made to the affect location in the affect space. In another example, only a subset of inputs may be used according to aspects disclosed herein, such that inputs may be randomly or programmatically selected or filtered when determining the affect location in the affect space. While example techniques for generating an affect location in affect space based on one or more inputs are discussed herein, it will be appreciated that any of a variety of other techniques may be used. Aspects of robot personality are also discussed in U.S. patent application Ser. No. 15/818,133, titled “INFINITE ROBOT PERSONALITIES,” the entirety of which is hereby incorporated by reference.

As illustrated, the control system 175 further comprises a skill data store 102. In an example, at least some of the skills of the robot 170 may be stored using the skill data store 102. For example, the skill data store 102 may comprise pre-programmed skills, installed skills, or dynamically generated skills, among other examples. In another example, the skill data store 102 may store one or more skills loaded onto the robot by a user (e.g., using an application, website, or other management interface on a computing device, as a result of a user providing an indication to the robot to load a skill, etc.). In another example, the skill data store 102 may store metadata associated with a skill, including, but not limited to, the number of times a skill has been executed, how long the robot 170 has spent executing the skill, and/or a sentiment associated with the skill (e.g., how the skill affects an affective state for the robot 170, how the skill affects a perceived or explicit affective state of a user, etc.). While the robot 170 is described herein with respect to a set of local skills stored by the skill data store 102, it will be appreciated that the robot 170 may access, process, and/or execute skills from any of a variety of other sources, including, but not limited to, a computer storage media, a computing device, or a remote data store, or any combination thereof.

As illustrated, the control system 175 further comprises a context evaluation engine 103. The context evaluation engine 103 may generate context information based on an evaluation of any of a variety of input, including, but not limited to, information received from one or more sensors of the robot 170 (e.g., the optical sensor 172 and/or the audio devices 177, etc.), information received from a user, stored or historical context information, external sources (e.g., a computing device, a remote platform, etc.), and/or environmental factors (e.g., as may be determined by one or more sensors, accessed from a computing device, etc.). As an example, environmental factors may comprise identifying the sound of a doorbell, whether the television is on, room temperature, and/or the presence of people, pets, or other robots, among other factors. In some examples, the context evaluation engine 103 may evaluate only a portion of the input, such that the generated context information may relate to a subset of the input. In other examples, the context evaluation engine 103 may evaluate all of the input when generating context information, such that the context information is generated based on all of the context available to the robot 170. In another example, the context evaluation engine 103 may evaluate different aspects of the input, such that a varying subset of the input may be evaluated at a given time. The context evaluation engine 103 may determine which subset of input to evaluate based on any of a variety of factors, including, but not limited to, a skill currently being executed by the robot 170, the location of the robot 170, and/or objects surrounding the robot 170, among others. As discussed herein, the context information generated based on the above-discussed inputs may ultimately be used to determine a skill for the robot to execute. While example input and is described herein, it will be appreciated that other types of input may be used by the context evaluation engine 103.

The control system 175 further comprises a skill determination engine 104. In an example, the skill determination engine 104 may generate a skill importance metric for each of the evaluated skills, such that the skills may be ordered based on their respective skill importance metric. The ordered list of skills may then be evaluated to identify a skill that may be executed by the robot 170. As discussed above, the skill determination engine 104 may determine a skill periodically and/or in response to the occurrence of an event, among other triggers. In some examples, the skills from which the skill determination engine 104 determines a skill may be stored by the skill data store 102, or may be stored by any of a variety of other sources, including, but not limited to, a computer storage media, a computing device, or a remote data store, or any combination thereof.

When generating a skill importance metric for a skill, the skill determination engine 104 may evaluate skill relevancy metrics associated with skills of the robot 170. As an example, context information (e.g., as may be generated by the context evaluation engine 103) may be used to generate a skill relevancy metric for a skill. In some examples, context information may be evaluated based on information provided by a skill, wherein the skill may comprise an algorithm, category information, and/or a list of objects for which the skill is relevant, among other factors. In other examples, the robot 170 may maintain information useable to determine the skill relevancy metric based on context information, as may be stored by skill data store 102. As an example, the robot 170 may generate an association between a skill and aspects of context information when a user activates the skill, such that the robot 170 may learn to identify a context in which the skill is relevant.

While example skill relevancy metric determination techniques are disclosed, it will be appreciated that any of a variety of other techniques may be used in addition to or as an alternative to the techniques described herein. Further, examples are described herein with respect to generating a skill relevancy metric for a given skill. However, it will be appreciated that, in some examples, a skill relevancy metric may be generated for a given skill/object pair, wherein a skill may have a different skill relevancy metric depending on the object to which it relates. In other examples, a skill may be paired with any number of a variety of other variables when generating a skill relevancy metric.

In some examples, the skill determination engine 104 may evaluate metadata associated with a skill (e.g., as may be stored by the skill data store 102) to generate a skill importance metric for a skill. As an example, the skill importance metric may be generated based on an evaluation of the number of times the skill has been executed, how long the robot 170 has spent executing the skill, and/or a sentiment associated with the skill (e.g., how the skill affects an affective state for the robot 170, how the skill affects a perceived or explicit affective state of a user, etc.), among other metadata. For example, a skill that is frequently executed by the robot 170 may be determined to have a higher skill importance metric than a skill that is rarely, if ever, executed by the robot 170. In another example, it may be determined by the robot 170 that skills that are rarely performed by the robot 170 should be performed so as to “practice” such skills. Accordingly, a skill that the robot has spent less time performing may be determined to have a higher skill importance metric than a skill that the robot 170 has spent a large amount of time performing.

While example factors for generating a skill importance metric are described herein, it will be appreciated that the skill determination engine 104 may evaluate any of a wide variety of other factors. As an example, a skill may be associated with a constant, such that the constant may be factored into the skill importance metric. In some examples, the constant may be a multiplier used to increase the skill importance metric of a skill as compared to other skills. In other examples, the constant may be a divisor that decreases the skill importance metric of a skill as compared to other skills. Further, examples are described herein with respect to generating a skill importance metric for a given skill. However, it will be appreciated that, in some examples, a skill importance metric may be generated for a given skill/object pair, wherein a skill may have a different skill importance metric depending on the object to which it relates. In other examples, a skill may be paired with any number of a variety of other variables when generating a skill importance metric.

As illustrated, the control system 175 further comprises skill execution engine 105. In an example, a skill may be determined for execution (e.g., by the skill determination engine 104) and executed by the skill execution engine 105. Accordingly, the skill execution engine 105 may evaluate aspects of the determined skill and identify one or more operations the robot 170 should perform in order to execute the skill. In some examples, the evaluation may comprise evaluating context information (e.g., as may be generated by context evaluation engine 103) in order to determine which set of operations and/or which subset of operations should be performed by the robot 170.

In an example, one or more operations of a skill may be associated with a parameter. For example, a move operation may have a speed parameter at which the robot 170 should move. In some examples, the skill may specify the parameter, while in other examples, the robot 170 may determine the parameter (e.g., when executing the skill, when the skill is evaluated by skill determination engine 104, etc.). As an example, a run skill may specify that the property of the speed parameter should be fast, or may indicate a specific speed or range of speeds at which the robot 170 should move. As another example, a “go outside” skill may not specify the speed parameter, such that the robot may determine one or more properties of the speed parameter based on its affective state or the context information, among other factors. While example skills and parameters are described herein, it will be appreciated that any of a variety of others may be used.

In some examples, a region of an action space for the robot 170 comprising a class of relevant parameters for performing an operation may be determined, such that parameters within the class may be selected when the robot 170 performs and operation. In an example, the parameter may be selected from within the class based at least in part on the affective state of the robot 170, as may be defined by the robot personality engine 106 as discussed above. In an example, properties of a selected parameter may be adapted based on the affective state (e.g., the speed at which an action is performed, the pitch at which a sound is played, etc.).

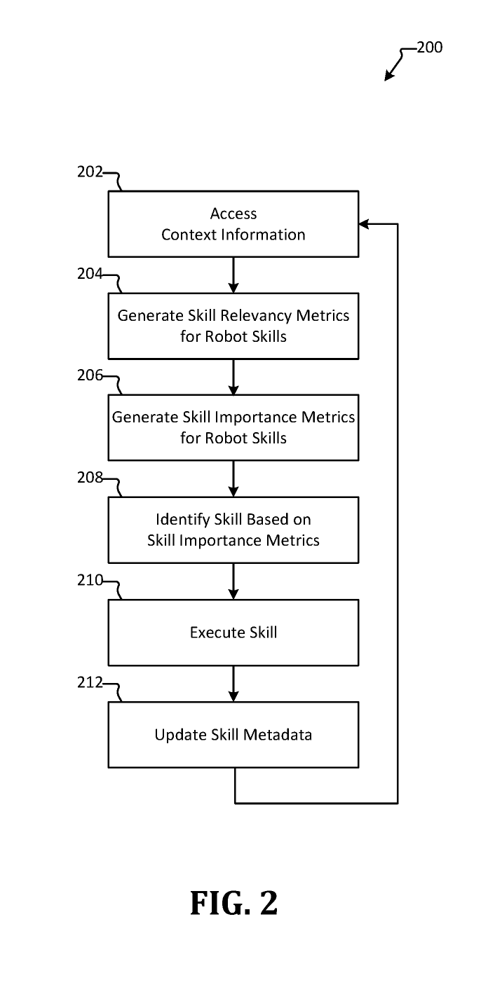

FIG. 2 depicts an example of a method 200 for robot skill management. In an example, the method 200 may be executed or otherwise performed, at least in part, by a skill determination engine, such as the skill determination engine 104 of the robot 170 in FIG. 1B. In some examples, the method 200 may be performed periodically or in response to the occurrence of an event, among other triggers. In other examples, the method 200 may be performed while the robot is already performing a skill or while the robot is idle, or in any of a variety of other circumstances.

The method 200 begins at operation 202, where context information may be accessed. In an example, the context information may be generated by a context evaluation engine, such as the context evaluation engine 103 in FIG. 1B. As discussed above, context information may be generated based on a variety of input, including, but not limited to, information received from one or more sensors of the robot, information received from a user, stored or historical context information, external sources (e.g., a computing device, a remote platform, etc.), and/or environmental factors, among other input. In some examples, only a part of the context information may be accessed, such that the method 200 may be performed using only a subpart of the context information. As an example, a robot may maintain a comprehensive set of context information, such that only the context information immediately relevant to the skills of the robot may be processed by the method 200. While example context information is described herein, it will be appreciated that additional and/or alternative context information may be processed by the method 200.

Flow progresses to operation 204, where skill relevancy metrics may be generated for one or more skills of the robot. In some examples, skill relevancy metrics may be generated by a skill determination engine, such as the skill determination engine 104 in FIG. 1B. In an example, skills in a skill data store (e.g., as may be stored by the skill data store 102 in FIG. 1B) may be processed. In another example, skills from additional and/or alternative locations may be processed, such as may be stored by a computer storage media, a computing device, or a remote data store, or any combination thereof.

Skill relevancy metrics may be generated based on the accessed context information. In some examples, a skill relevancy metric may be generated using information provided by a skill, wherein the skill may comprise an algorithm, category information, and/or a list of objects for which the skill is relevant, among other factors, which may be used to evaluate the context information. In other examples, information may be maintained by the robot (e.g., in a skill data store such as skill data store 102 in FIG. 1B), which may be useable to determine the skill relevancy metric for the skill based on context information. As an example, an association may be generated between a skill and aspects of context information when a user activates the skill, such that one or more contexts may be identified in which the skill is relevant. While example skill relevancy metric determination techniques are disclosed, it will be appreciated that any of a variety of other techniques may be used in addition to or as an alternative to the techniques described herein.

At operation 206, a skill importance metric may be determined for one or more skills of the robot. As discussed above, a skill importance metric may be generated based on a variety of factors. As an example, the skill importance metric for a skill may be generated at least in part using the skill relevancy metric for the skill that was determined at operation 204. In another example, metadata associated with a skill may be used to generate the skill importance metric for the skill. For example, the metadata may comprise information relating to the number of times the skill has been executed, how long the robot has spent executing the skill, and/or a sentiment associated with the skill (e.g., how the skill affects an affective state for the robot, how the skill affects a perceived or explicit affective state of a user, etc.), among other metadata. In some examples, a constant associated with the skill may be used to generate the skill importance metric, among other factors.

Generating the skill importance metric may comprise performing any of a variety of mathematical operations using the above-discussed factors. In another example, a model may be used, wherein the factors may be entered into the model as inputs, such that the model may output a skill importance metric based on the inputs. While example techniques are described herein for generating a skill importance metric based on one or more factors, it will be appreciated that any of a variety of other techniques may be used.

Flow progresses to operation 208, where a skill may be identified based on the skill importance metrics generated at operation 206. In some examples, the skill may be identified by a skill determination engine, such as the skill determination engine 104 in FIG. 1B. In an example, identifying the skill may comprise ranking the skills of the robot based on each respective skill importance metric, such that one or more skills having the highest skill importance metric may be identified. As an example, a skill having the highest skill importance metric may be identified at operation 208. In another example, the identification may comprise evaluating skill importance metrics based on a threshold, wherein skills above a threshold may be identified as candidates. In such an example, a skill may be randomly selected from candidates above the threshold, or may be selected based on any of a variety of other criteria. While example identification techniques are described, it will be appreciated that a skill may be identified based on skill importance metrics using any of a variety of other techniques.

Moving to operation 210, the identified skill may be executed. In an example, the skill may be executed by a skill execution engine, such as the skill execution engine 105 in FIG. 1B. In another example, aspects of the skill may be evaluated to determine one or more operations that the robot should perform. In some examples, the evaluation may comprise evaluating context information (e.g., as may be accessed at operation 202) in order to determine which set of operations and/or which subset of operations of the skill should be performed by the robot 170. In other examples, one or more operations of a skill may be associated with a parameter. In some instances, the skill may specify or otherwise constrain properties of the parameter, while in other examples, properties of the parameter may unconstrained and may therefore be dynamically determined (e.g., when executing the skill, when the skill is identified at operation 208, etc.).

At operation 212, metadata associated with the identified skill may be updated. In some examples, operation 212 may be an optional operation, may be omitted, or may be performed earlier in the flow of method 200. For example, operation 212 may be performed prior to operation 210. Updating metadata may comprise modifying, updating, removing, and/or adding metadata associated with the skill, as may be stored by a skill data store, such as the skill data store 102 in FIG. 1B. In some examples, the metadata may be updated based on aspects of the execution of the skill at operation 210, wherein at least a part of the information used to update the metadata may be generated as a result of executing the skill. As discussed above, the metadata may comprise a number of times the skill has been executed, how long the robot has spent executing a skill, and/or a sentiment associated with the skill (e.g., how the skill affects an affective state for the robot 170, how the skill affects a perceived or explicit affective state of a user, etc.), among other metadata. It will be appreciated that additional and/or alternative metadata may be maintained without departing from the spirit of this disclosure.

The method 200 is illustrated as looping between 202 and 212 to indicate that the method 200 may be periodically performed. Accordingly, in some examples, flow may return to operation 202, such that operations 202-212 may be performed again to either identify a new skill for execution or to continue executing the skill that was identified when operation 208 was previously executed. In another example, flow may not loop between operations 202 and 212, such that flow may terminate at operation 212.

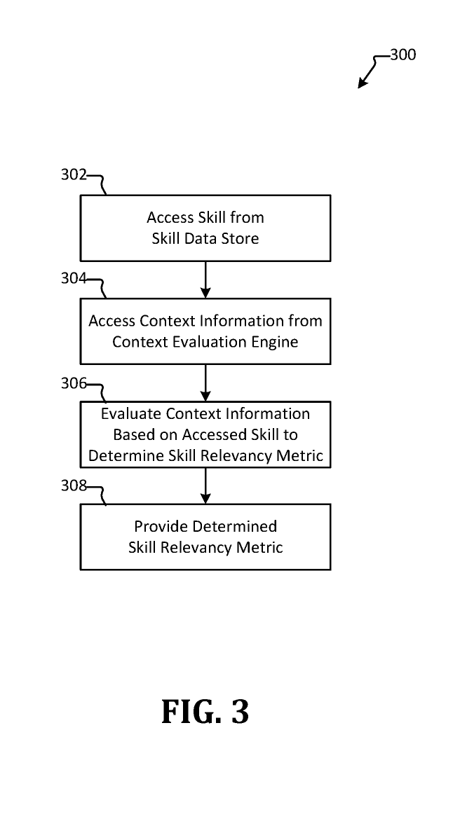

FIG. 3 depicts an example of a method 300 for determining a skill relevancy metric for a skill. In an example, aspects of the method 300 may be performed by a skill determination engine, such as the skill determination engine 104 in FIG. 1B. In another example, aspects of the method 300 may be performed at operation 204 of the method 200 in FIG. 2 to generate skill relevancy metrics for skills of a robot, as discussed above.

The method 300 begins at operation 302, where a skill may be accessed from a skill data store. In an example, the skill may be accessed from the skill data store 102 in FIG. 1B. In another example, the skill may be accessed from any of a variety of other sources, including, but not limited to, a computer storage media, a computing device, or a remote data store, or any combination thereof.

Flow progresses to operation 304, where context information may be accessed from a context evaluation engine. In an example, the context information may be generated by context evaluation engine 103, as was discussed above with respect to FIG. 1B. As an example, context information may be generated based on a variety of input, including, but not limited to, information received from one or more sensors of the robot, information received from a user, stored or historical context information, and/or external sources (e.g., a computing device, a remote platform, etc.). In some examples, only a part of the context information may be accessed, such that the method 300 may be performed using only a subpart of the context information. While example context information is described herein, it will be appreciated that additional and/or alternative context information may be processed by the method 300.

At operation 306, the context information may be evaluated based on the accessed skill in order to determine a skill relevancy metric for the skill. In some examples, the skill may comprise an algorithm, category information, and/or a list of objects for which the skill is relevant, among other factors. Such factors may be used to evaluate the context information accordingly in order to generate a skill relevancy metric. In other examples, the skill may provide one or more factors that may be entered into a model in order to determine the skill relevancy metric. Thus, each skill may provide one or more factors with which context information may be evaluated, such that the robot need not have previous knowledge about the context in which a skill may be relevant.

In other examples, information for a skill may be maintained by the robot (e.g., in a skill data store such as skill data store 102 in FIG. 1B), which may be useable to determine a skill relevancy metric for the skill based on the accessed context information. As an example, an association may be generated between a skill and aspects of context information when a user activates the skill, such that one or more contexts may be identified in which the skill is relevant. In such a scenario, rather than a skill providing factors as discussed above, such factors may instead be generated dynamically. While example skill relevancy metric determination techniques are disclosed, it will be appreciated that any of a variety of other techniques may be used in addition to or as an alternative to the techniques described herein. In some examples, a combination of factors provided by a skill and generated associations may be used.

Flow progresses to operation 308, where the determined skill relevancy metric may be provided. As an example, the determined skill relevancy metric may comprise a numeric score, a data set comprising one or more contexts in which the skill may be relevant, and/or a set of values that may be entered into a model to compare the determined skill relevancy metric with that of another skill, among other examples. As another example, the skill relevancy metric may comprise a multi-dimensional vector, a probability, or a probability distribution. In some examples, the determined skill relevancy metric may be provided for use by a skill determination engine, such as the skill determination engine 104 in FIG. 1B. In other examples, the determined skill relevancy metric may be provided to a method for robot skill management, such as the method 200 in FIG. 2. In another example, the determined skill relevancy metric may be provided for use when generating a skill importance metric according to aspects disclosed herein. While example skill relevancy metrics are described herein, it will be appreciated that a skill relevancy metric may be of any type that enables a comparison of the skill relevancy metric with another skill relevancy metric. Flow terminates at operation 308.

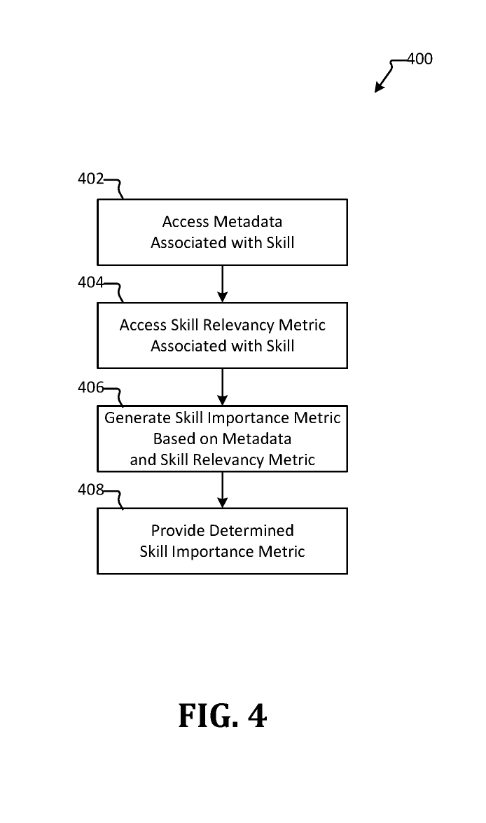

FIG. 4 depicts an example of a method 400 for determining a skill importance metric for a skill. In an example, aspects of the method 400 may be performed by a skill determination engine, such as the skill determination engine 104 in FIG. 1B. In another example, aspects of the method 400 may be performed at operation 206 of the method 200 in FIG. 2 to generate skill importance metrics for skills of a robot, as discussed above.

The method 400 begins at operation 402, where metadata associated with a skill may be accessed. In some examples, the metadata may be accessed from a skill data store, such as the skill data store 102 in FIG. 1B. As described above, metadata associated with a skill may comprise a number of times a skill has been executed, how long the robot has spent executing a skill, and/or a sentiment associated with the skill (e.g., how the skill affects an affective state for the robot 170, how the skill affects a perceived or explicit affective state of a user, etc.), among other metadata.

Flow progresses to operation 404, where a skill relevancy metric associated with the skill may be accessed. In some examples, the skill relevancy metric may have been generated according to aspects of the method 300 as discussed above with respect to FIG. 3. For example, the skill relevancy metric may have been generated based on factors provided by the skill and/or based on one or more associations generated by the robot.

At operation 406, a skill importance metric may be generated for the skill based on the metadata and the skill relevancy metric. In an example, generating the skill importance metric may comprise performing any of a variety of mathematical operations using the skill relevancy metric and at least a part of the metadata associated with the skill. In another example, a model may be used, wherein the skill relevancy metric and the metadata associated with the skill may be entered into the model as inputs, such that the model may be used to generate the skill importance metric. It will be appreciated that while the method 400 is discussed with respect to generating the skill importance metric using a combination of the skill relevancy metric and metadata, the skill importance metric may be generated based on additional and/or alternative factors. Further, while example techniques are described herein for generating a skill importance metric based on one or more factors, it will be appreciated that any of a variety of other techniques may be used.

Moving to operation 408, the determined skill importance metric may be provided. As an example, the determined skill importance metric may comprise a numeric score, a data set comprising one or more contexts in which the skill may be important, and/or a set of values that may be entered into a model to compare the determined skill importance metric with that of another skill, among other examples. As another example, the skill importance metric may comprise a multi-dimensional vector, a probability, or a probability distribution. In an example, the skill importance metric may be provided for use by a skill determination engine, such as the skill determination engine 104 in FIG. 1B. In other examples, the determined skill importance metric may be provided to a method for robot skill management, such as the method 200 in FIG. 2. While example skill importance metrics are described herein, it will be appreciated that a skill importance metric may be of any type that enables a comparison of the skill importance metric with another skill importance metric. Flow terminates at operation 408.

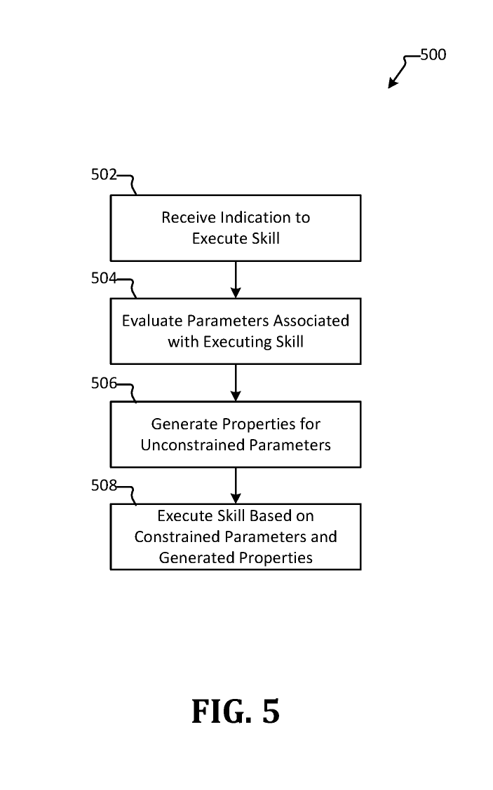

FIG. 5 depicts an example of a method 500 for executing a skill by a robot. In an example, aspects of the method 500 may be performed by a skill execution engine, such as the skill execution engine 105 of the robot 170 in FIG. 1B. In another example, aspects of the method 500 may be performed at operation 210 of the method 200 in FIG. 2, as discussed above.

The method 500 begins at operation 502, where an indication may be received to execute a skill. In some examples, the indication may be received as a result of determining a skill to execute, as may be determined by a skill determination engine, such as the skill determination engine 104 in FIG. 1B. In other examples, the indication may comprise context information (e.g., as may be generated by a context evaluation engine, such as the context evaluation engine 103 in FIG. 1B).

Flow progresses to operation 504, where parameters associated with the skill may be evaluated. In some examples, the evaluation may comprise determining one or more operations associated with executing the skill. One or more parameters may be determined for the operations, each of which may be a constrained parameter or an unconstrained parameter, as may be specified by the skill. In an example, a skill may constrain a parameter for an operation, such that the operation will be performed based on the constraint. For example, a “run” skill may constrain the property of a speed parameter of a move operation to be fast, such that the robot will move fast when performing the move operation. In another example, parameters of an operation may be unconstrained, such that a property for the parameter may be dynamically determined (e.g., when executing the skill, when the skill is determined to be performed by a skill determination engine, etc.).

At operation 506, properties may be generated for unconstrained parameters. In an example, a property for a parameter may be generated randomly (e.g., selected from a set of possible properties for the parameter, a random value, etc.). In another example, a property for a parameter may be programmatically selected. For example, a property may be selected based on a current affective state for the robot and/or based on the personality of the robot (e.g., as may be determined by the robot personality engine 106 in FIG. 1B). While example property generation techniques for a parameter are described, it will be appreciated that a property may be generated for an unconstrained parameter using any of a variety of techniques.

Moving to operation 508, the skill may be executed based on the constrained parameters (e.g., as may be specified by the skill) and based on the generated properties for the unconstrained parameters. In an example, the skill may be executed by skill execution engine 105 in FIG. 1B. As described above, executing the skill may comprise performing one or more operations specified by the skill. In an examples, context information (e.g., as may be generated by context evaluation engine 103) may be evaluated in order to determine which set of operations and/or which subset of operations of a skill should be performed. Flow terminates at operation 508.

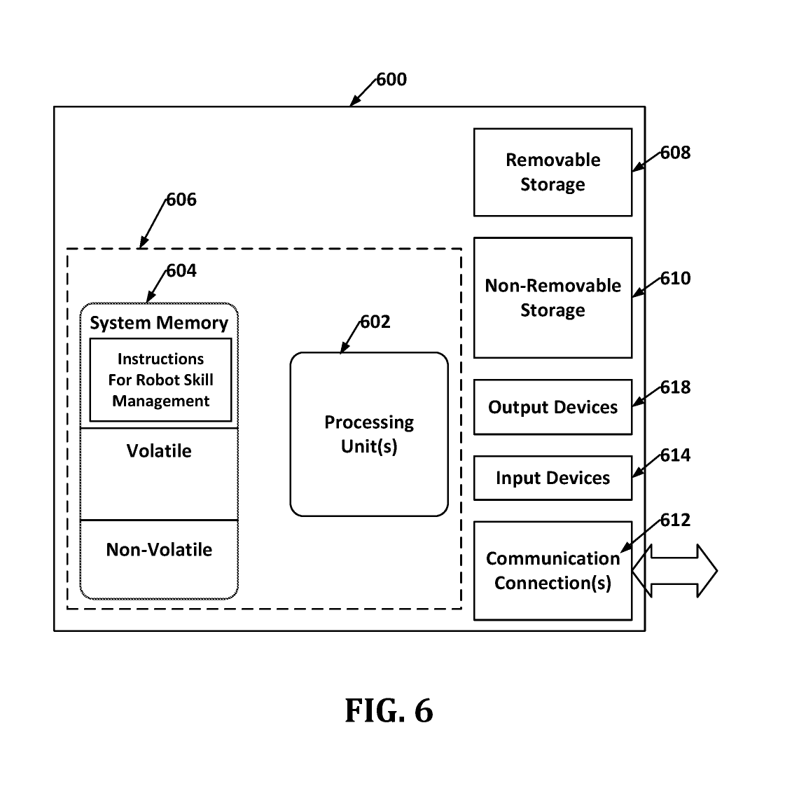

FIG. 6 illustrates another example of a suitable operating environment 600 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 600 typically includes at least one processing unit 602 and memory 604. Depending on the exact configuration and type of computing device, memory 604 (instructions to perform robot skill management as described herein) may be volatile (such as RAM), non-volatile (such as ROM, flash memory, etc.), or some combination of the two. This most basic configuration is illustrated in FIG. 6 by dashed line 606. Further, environment 600 may also include storage devices (removable, 608, and/or non-removable, 610) including, but not limited to, magnetic or optical disks or tape. Similarly, environment 600 may also have input device(s) 614 such as keyboard, mouse, pen, voice input, etc. and/or output device(s) 616 such as a display, speakers, printer, etc. Also included in the environment may be one or more communication connections, 612, such as LAN, WAN, point to point, etc.

Operating environment 600 typically includes at least some form of computer readable media. Computer readable media can be any available media that can be accessed by processing unit 602 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The operating environment 600 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

As will be understood from the foregoing disclosure, one aspect of the technology relates to a robotic device comprising: at least one processor; and memory encoding computer executable instructions that, when executed by the at least one processor, perform a method. The method comprises: generating, for each skill of a set of skills for the robotic device, a skill relevancy metric, wherein the skill relevancy metric indicates a relevancy of the skill for a context of the robotic device; generating, for each skill of the set of skills, a skill importance metric, wherein the importance metric is based at least in part on the skill relevancy metric for the skill; determining a skill from the set of skills based on the generated skill importance metrics; and executing, by the robotic device, the determined skill. In an example, generating the skill relevancy metric comprises at least one of: evaluating the context based on one or more factors of the skill; and evaluating an association generated by the robotic device between the skill and a previous context for the robotic device. In another example, generating the skill importance metric further comprises evaluating at least one of: metadata associated with the skill; and one or more constants associated with the skill. In a further example, the metadata comprises at least one of: a number of times the skill has been executed by the robot; an amount of time the robot has spent executing the skill; a sentiment associated with the skill for the robotic device; and a sentiment associated with the skill for a user of the robotic device. In yet another example, determining the skill from the set of skills comprises identifying the skill from the set of skills having the highest generated skill importance metric as compared to other skills in the set of skills. In a further still example, executing the determined skill comprises performing one or more operations associated with the skill, wherein the one or more operations is associated with a parameter. In an example, the parameter is an unconstrained parameter, and performing one or more operations associated with the skill comprises: determining, by the robotic device, a property for the unconstrained parameter; and performing the one or more operations based on the determined property.

In another aspect, the technology relates to a computing device comprising: at least one processor; and memory encoding computer executable instructions that, when executed by the at least one processor, perform a method. The method comprises: generating, for each skill of a set of skills, a skill relevancy metric, wherein the skill relevancy metric indicates a relevancy of the skill for a context of the computing device; generating, for each skill of the set of skills, a skill importance metric, wherein the importance metric is based at least in part on the skill relevancy metric for the skill; determining a skill from the set of skills based on the generated skill importance metrics; and executing the determined skill. In an example, generating the skill relevancy metric comprises at least one of: evaluating the context based on one or more factors of the skill; and evaluating an association between the skill and a previous context for the computing device. In another example, generating the skill importance metric further comprises evaluating at least one of: metadata associated with the skill; and one or more constants associated with the skill. In a further example, determining the skill from the set of skills comprises identifying the skill from the set of skills having the highest generated skill importance metric as compared to other skills in the set of skills. In yet another example, the determined skill comprises a set of operations that is useable by the computing device to perform a task. In a further still example, at least one operation of the set of operations is associated with an unconstrained parameter, and executing the determined skill comprises: determining a property for the unconstrained parameter; and performing the at least one operation based on the determined property.

In another aspect, the technology relates to a method for managing a set of skills. The method comprises: generating, for each skill of the set of skills, a skill relevancy metric, wherein the skill relevancy metric indicates a relevancy of the skill for a context; generating, for each skill of the set of skills, a skill importance metric, wherein the importance metric is based at least in part on the skill relevancy metric for the skill; determining a skill from the set of skills based on the generated skill importance metrics; and executing the determined skill. In an example, generating the skill relevancy metric comprises at least one of: evaluating the context based on one or more factors of the skill; and evaluating an association between the skill and a previous context. In another example, generating the skill importance metric further comprises evaluating at least one of: metadata associated with the skill; and one or more constants associated with the skill. In a further example, the metadata comprises at least one of: a number of times the skill has been executed; an amount of time spent executing the skill; a sentiment associated with the skill for a device; and a sentiment associated with the skill for a user of the device. In yet another example, determining the skill from the set of skills comprises identifying the skill from the set of skills having the highest generated skill importance metric as compared to other skills in the set of skills. In a further still example, executing the determined skill comprises performing one or more operations associated with the skill, wherein the one or more operations is associated with a parameter. In an example, the parameter is an unconstrained parameter, and performing one or more operations associated with the skill comprises: determining a property for the unconstrained parameter; and performing the one or more operations based on the determined property.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A robotic device comprising:
at least one processor; and
memory encoding computer executable instructions that, when executed by the at least one processor, perform a method comprising:
generating, for each skill of a set of skills for the robotic device, a skill relevancy metric, wherein the skill relevancy metric indicates a relevancy of the skill for a context of the robotic device;
generating, for each skill of the set of skills, a skill importance metric, wherein the importance metric is based at least in part on the skill relevancy metric for the skill;
determining a skill from the set of skills based on the generated skill importance metrics; and
executing, by the robotic device, the determined skill.

2. The robotic device of claim 1, wherein generating the skill relevancy metric comprises at least one of:
evaluating the context based on one or more factors of the skill; and
evaluating an association generated by the robotic device between the skill and a previous context for the robotic device.

3. The robotic device of claim 1, wherein generating the skill importance metric further comprises evaluating at least one of:
metadata associated with the skill; and
one or more constants associated with the skill.

4. The robotic device of claim 3, wherein the metadata comprises at least one of:
a number of times the skill has been executed by the robot;
an amount of time the robot has spent executing the skill;
a sentiment associated with the skill for the robotic device; and
a sentiment associated with the skill for a user of the robotic device.

5. The robotic device of claim 1, wherein determining the skill from the set of skills comprises identifying the skill from the set of skills having the highest generated skill importance metric as compared to other skills in the set of skills.

6. The robotic device of claim 1, wherein executing the determined skill comprises performing one or more operations associated with the skill, wherein the one or more operations is associated with a parameter.

7. The robotic device of claim 6, wherein the parameter is an unconstrained parameter, and wherein performing one or more operations associated with the skill comprises:
determining, by the robotic device, a property for the unconstrained parameter; and
performing the one or more operations based on the determined property.

8. A computing device comprising:
at least one processor; and
memory encoding computer executable instructions that, when executed by the at least one processor, perform a method comprising:
generating, for each skill of a set of skills, a skill relevancy metric, wherein the skill relevancy metric indicates a relevancy of the skill for a context of the computing device;
generating, for each skill of the set of skills, a skill importance metric, wherein the importance metric is based at least in part on the skill relevancy metric for the skill;
determining a skill from the set of skills based on the generated skill importance metrics; and
executing the determined skill.

9. The computing device of claim 8, wherein generating the skill relevancy metric comprises at least one of:
evaluating the context based on one or more factors of the skill; and
evaluating an association between the skill and a previous context for the computing device.

10. The computing device of claim 8, wherein generating the skill importance metric further comprises evaluating at least one of:
metadata associated with the skill; and
one or more constants associated with the skill.

11. The computing device of claim 8, wherein determining the skill from the set of skills comprises identifying the skill from the set of skills having the highest generated skill importance metric as compared to other skills in the set of skills.

12. The computing device of claim 8, wherein the determined skill comprises a set of operations that is useable by the computing device to perform a task.

13. The computing device of claim 12, wherein at least one operation of the set of operations is associated with an unconstrained parameter, and wherein executing the determined skill comprises:
determining a property for the unconstrained parameter; and
performing the at least one operation based on the determined property.

14. A method for managing a set of skills, comprising:
generating, for each skill of the set of skills, a skill relevancy metric, wherein the skill relevancy metric indicates a relevancy of the skill for a context;
generating, for each skill of the set of skills, a skill importance metric, wherein the importance metric is based at least in part on the skill relevancy metric for the skill;
determining a skill from the set of skills based on the generated skill importance metrics; and
executing the determined skill.

15. The method of claim 14, wherein generating the skill relevancy metric comprises at least one of:
evaluating the context based on one or more factors of the skill; and
evaluating an association between the skill and a previous context.

16. The method of claim 14, wherein generating the skill importance metric further comprises evaluating at least one of:
metadata associated with the skill; and
one or more constants associated with the skill.

17. The method of claim 16, wherein the metadata comprises at least one of:
a number of times the skill has been executed;
an amount of time spent executing the skill;
a sentiment associated with the skill for a device; and
a sentiment associated with the skill for a user of the device.

18. The method of claim 14, wherein determining the skill from the set of skills comprises identifying the skill from the set of skills having the highest generated skill importance metric as compared to other skills in the set of skills.

19. The method of claim 14, wherein executing the determined skill comprises performing one or more operations associated with the skill, wherein the one or more operations is associated with a parameter.

20. The method of claim 19, wherein the parameter is an unconstrained parameter, and wherein performing one or more operations associated with the skill comprises:
determining a property for the unconstrained parameter; and
performing the one or more operations based on the determined property.
